(19) United States
(12) Patent Application Publication
(10) Pub. No.: US 2010/0096979 A1
(43) Pub. Date: Apr. 22, 2010

(54) METHOD OF MANUFACTURING METAL OXIDE ELECTRODE AND ORGANIC LIGHT EMITTING DIODE DISPLAY USING THE SAME

(76) Inventors: Jaeyoung Lee, Jung-ri (KR); Heeseok Yang, Gumi-si (KR); Hyodae Bae, Jung-gu (KR); Hanki Kim, Gumi-si (KR)

Correspondence Address: BRINKS HOFER GILSON & LIONE, P.O. BOX 10395, CHICAGO, IL, 60610, US

(21) Appl. No.: 12/481,893

(22) Filed: Jun. 10, 2009

(30) Foreign Application Priority Data
Oct. 20, 2008 (KR) 10-2008-0102583

(51) Int. Cl. H01J 1/62; H01J 9/00

(52) U.S. Cl. 313/504; 445/46

(57) ABSTRACT

A method of manufacturing a metal oxide electrode and an organic light emitting diode (OLED) display using the same are provided. The method includes providing a substrate inside a chamber, providing Al₂O₃ doped ZnO (AZO) including zinc oxide (ZnO) and aluminum oxide (Al₂O₃) inside the chamber, providing indium tin oxide (ITO) including indium oxide (In₂O₃) and tin oxide (SnO₂) inside the chamber, and applying a direct current (DC) power to a material including AZO and ITO to form an IAZTO electrode on the substrate.

### RELATED APPLICATIONS

This application claims the benefit of Korean Patent Application No. 10-2008-102583 filed on Oct. 20, 2008, the entire contents of which is hereby incorporated by reference.

### BACKGROUND

1. Field

Embodiments relate to a method of manufacturing a metal oxide electrode and an organic light emitting diode (OLED) display using the same.

2. Description of the Related Art

With the development of information technology, display devices have been widely used as a connection medium between a user and information. Hence, the use of flat panel displays such as a liquid crystal display (LCD), an organic light emitting diode (OLED) display, a plasma display panel (PDP) has been increasing.

Some of the display devices use a transparent conductive oxide (TCO) electrode. In the related art, indium tin oxide (ITO) with excellent electrical and optical properties was mainly used as a material of an oxide electrode, because ITO has a high transmittance and a low sheet resistance. However, a thermal process must be performed on an ITO electrode at a high temperature of about 300 to 350° C. so that the ITO electrode has a high transmittance and a low sheet resistance.

In the OLED display using an oxide electrode, the oxide electrode plays an important role. A work function of the oxide electrode serving as an anode electrode greatly affects light emitting characteristics of the OLD display.

However, in case of the related art using the ITO electrode as an anode electrode, a thermal process must be performed on the ITO electrode at a high temperature so that the ITO electrode has a high transmittance and a low sheet resistance. Accordingly, other oxide electrodes capable of replacing the ITO electrode are necessary.

### SUMMARY

In one aspect, there is disclosed a method of manufacturing a metal oxide electrode comprising providing a substrate inside a chamber, providing Al₂O₃ doped ZnO (AZO) including zinc oxide (ZnO) and aluminum oxide (Al₂O₃) inside the chamber, providing indium tin oxide (ITO) including indium oxide (In₂O₃) and tin oxide (SnO₂) inside the chamber, and applying a direct current (DC) power to a material including AZO and ITO to form an IAZTO electrode on the substrate.

In another aspect, there is disclosed an organic light emitting diode (OLED) display comprising a substrate and an organic light emitting layer between first and second electrodes that are positioned on the substrate, wherein the first electrode is formed of IAZTO including Al₂O₃ doped ZnO (AZO) and indium tin oxide (ITO), wherein AZO includes zinc oxide (ZnO) and aluminum oxide (Al₂O₃), and ITO includes indium oxide (In₂O₃) and tin oxide (SnO₂).

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 schematically shows a dual target DC sputtering system;

FIG. 2 is a flow chart of an exemplary method of manufacturing a metal oxide electrode according to an embodiment;

FIGS. 3 and 4 are characteristic graphs depending on DC power of AZO;

FIG. 5 shows an exemplary configuration of a subpixel using an IAZTO electrode according to an embodiment;

FIG. 6 is a graph comparing an embodiment using an IAZTO electrode with a related art using an ITO electrode;

FIG. 7 illustrates a circuit configuration of a subpixel according to an embodiment;

FIG. 8 is a cross-sectional view of a subpixel according to an embodiment; and

FIG. 9 illustrates a structure of an organic light emitting diode.

### DETAILED DESCRIPTION OF THE EMBODIMENTS

Reference will now be made in detail embodiments of the invention examples of which are illustrated in the accompanying drawings.

An exemplary method of manufacturing a display device according to an embodiment will be described below.

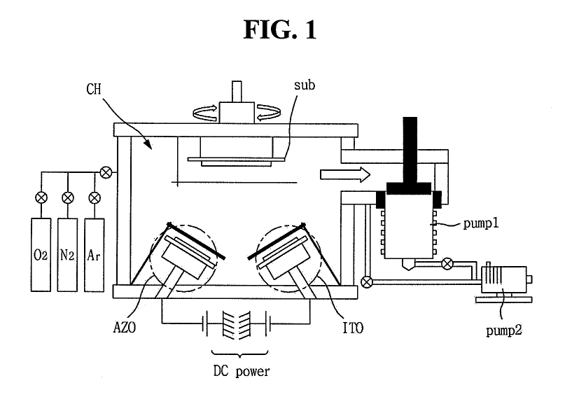

FIG. 1 schematically shows a dual target direct current (DC) sputtering system used to manufacture a metal oxide electrode. As shown in FIG. 1, the dual target DC sputtering system may include a diffusion pump pump1, a rotary pump pump2, etc. A substrate sub and two materials connected to a DC power supply unit are positioned inside a chamber CH of the dual target DC sputtering system.

In the dual target DC sputtering system, a gas such as oxygen (O₂), nitrogen (N₂), argon (Ar) is injected into the chamber CH, and DC power is applied to the two materials. Hence, sources resulting from the two materials are formed on the substrate sub.

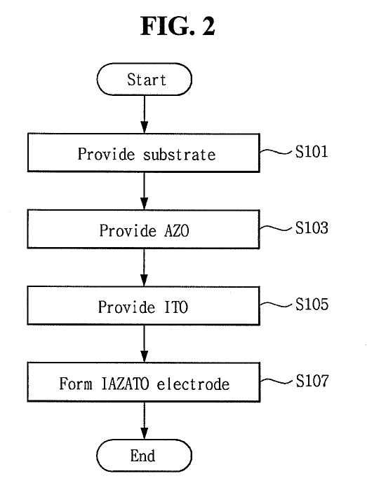

An exemplary method of manufacturing a metal oxide electrode according to an embodiment will be described below with reference to FIGS. 1 and 2.

First, the substrate sub is provided inside the chamber CH in step S101. The substrate sub may be formed using an element formation material with a high mechanical strength and high size stability. For example, the substrate sub may be formed of glass, metal, ceramic, or plastic such as polycarbonate resin, acrylic resin, vinyl chloride resin, polyethyleneterephthalate (PET) resin, polyimide resin, polyester resin, epoxy resin, silicon resin, fluorine resin.

Al₂O₃ doped ZnO (AZO) including zinc oxide (ZnO) and aluminum oxide (Al₂O₃) is provided inside the chamber CH in step S103. AZO may include about 2% to about 7% of Al₂O₃ based on total weight of AZO.

Indium tin oxide (ITO) including indium oxide (In₂O₃) and tin oxide (SnO₂) is provided inside the chamber CH in step S105. ITO may include about 5% to about 15% of SnO₂ based on total weight of ITO.

DC power is applied to a material including AZO and ITO to form an IAZTO electrode on the substrate sub in step S107.

In step S103 for providing AZO, when Al₂O₃ content is out of the above range (about 2% to about 7%), a phase of the IAZTO electrode may change in formation of the IAZTO electrode. Hence, characteristics of the IAZTO electrode are reduced. In step S105 for providing ITO, when SnO₂ content is out of the above range (about 5% to about 15%), a phase of the IAZTO electrode may change in formation of the IAZTO electrode. Hence, the characteristics of the IAZTO electrode are reduced. For example, when AZO includes 5% of Al₂O₃ based on total weight of AZO and ITO includes about 10% of SnO₂ based on total weight of ITO, the IAZTO electrode may have a resistivity of about 4.6×10⁻⁴ Ω·cm, a transmittance of 85% at a wavelength of visible light of 550 nm, and a work function of about 5.2 eV. On the other hand, when the Al₂O₃ content and the SnO₂ content are out of the above ranges, respectively, the resistivity of the IAZTO electrode is greater than about 4.6×10⁻⁴ Ω·cm and the transmittance of the IAZTO electrode is smaller than about 85%.

The following Table 1 indicates resistivity characteristic and transmittance characteristic of the IAZTO electrode depending on each of the Al₂O₃ content and the SnO₂ content. In the following Table 1, x, Δ, ∘, and ⊚ represent bad, normal, good, and excellent states of the characteristics, respectively.

TABLE 1

| | | Resistivity | Transmittance |
|---|---|---|---|
| Dopant | Percentage (%) | characteristic | characteristic |
| Aluminum oxide | 0-1 | X | X |
| (Al₂O₃) | 2-4 | ◯ | ◯ |
| | 5 | ⊚ | ⊚ |
| | 6-7 | ◯ | ◯ |
| | 8-10 | Δ | Δ |
| Tin oxide | 1-4 | X | X |
| (SnO₂) | 5-9 | ◯ | ◯ |
| | 10 | ⊚ | ⊚ |
| | 11-15 | ◯ | ◯ |
| | 16-20 | Δ | Δ |

In the above Table 1, when AZO includes 5% of Al₂O₃ based on total weight of AZO and ITO includes 10% of SnO₂ based on total weight of ITO, the IAZTO electrode has a resistivity of 4.6×10⁻⁴ Ω·cm, a transmittance of 85% at a wavelength of visible light of 550 nm, and a work function of 5.2 eV. Namely, when AZO includes 5% of Al₂O₃ based on total weight of AZO and ITO includes 10% of SnO₂ based on total weight of ITO, the resistivity characteristic and the transmittance characteristic of the IAZTO electrode are excellent.

In step S107 for forming the IAZTO electrode, process conditions for forming the IAZTO electrode on the substrate sub using AZO and ITO may be as follows: an internal pressure of the chamber CH is 3 mTorr; a flow rate of Ar gas injected into the chamber CH is 15 sccm; distances between the substrate sub and AZO and ITO are 100 mm; DC power applied to AZO is 0 to 100 W; and DC power applied to ITO is 100 W. Other process conditions may be used.

The characteristics such as the transmittance, the resistivity, a sheet resistance of the IAZTO electrode may vary depending on the above-described process conditions, such as the DC power applied to AZO and ITO, a kind and the flow rate of gas, the distances between the substrate sub and AZO and ITO, and the internal pressure of the chamber CH. Accordingly, the characteristics of the IAZTO electrode may vary by changing the above-described process conditions. In the present embodiment, the IAZTO electrode may have the resistivity of 4.6×10⁻⁴ Ω·cm and the transmittance of 85% at a wavelength of visible light of 550 nm using the above-described process conditions.

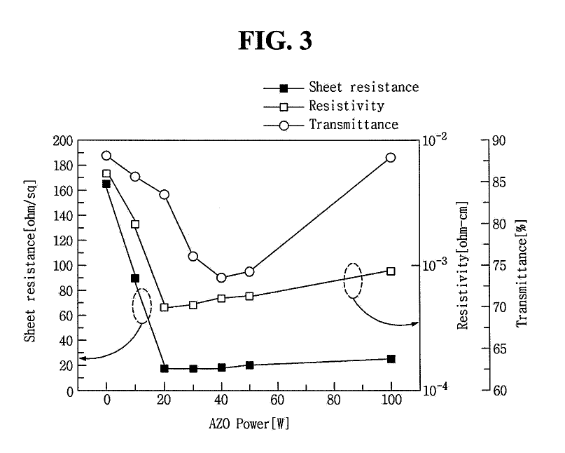

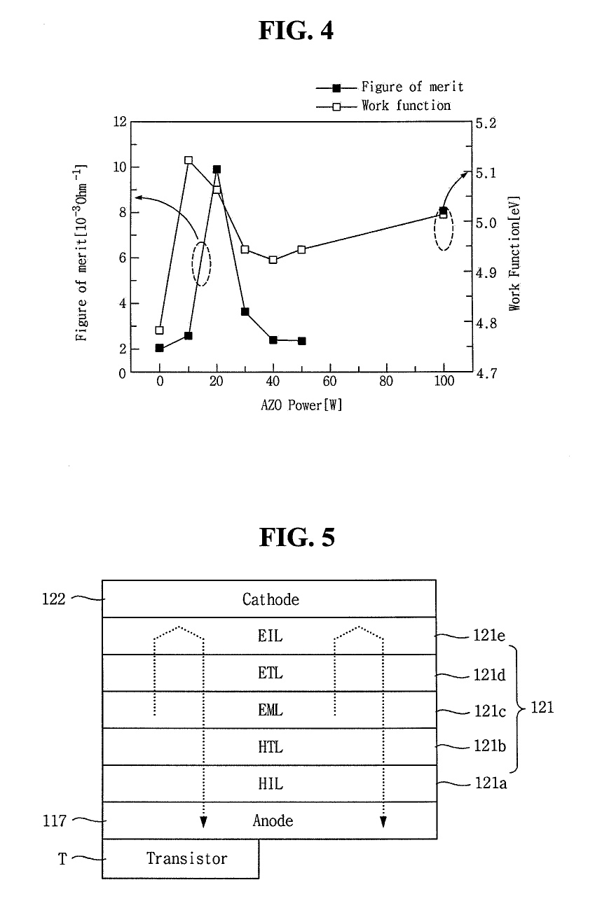

It can be seen from FIGS. 3 and 4 that when the DC power applied to AZO is 20 W, transmittance characteristics and sheet resistance characteristics of the IAZTO electrode are excellent.

FIG. 5 shows an exemplary configuration of a subpixel applied to a bottom emission type organic light emitting diode (OLED) display. As shown in FIG. 5, the IAZTO electrode serving as an anode electrode is connected to a source electrode or a drain electrode of a transistor T. In FIG. 5, the IAZTO electrode is called a first electrode 117. An organic light emitting layer 121 including a hole injection layer (HIL) 121a, a hole transport layer (HTL) 121b, a light emitting layer (EML) 121c, an electron transport layer (ETL) 121d, and an electron injection layer (EIL) 121e is formed on the first electrode 117. A cathode electrode formed of aluminum is formed on the organic light emitting layer 121. In FIG. 5, the cathode electrode is called a second electrode 122.

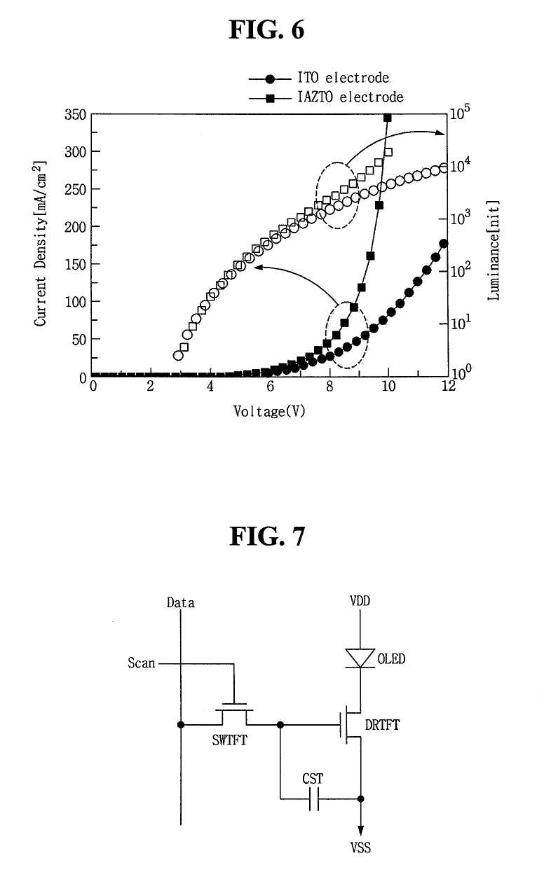

FIG. 6 is a graph that compares an embodiment using an IAZTO electrode as the first electrode 117 with a related art using an ITO electrode as the first electrode 117 under condition that OLED displays according to the embodiment and the related art have the configuration shown in FIG. 5. It can be seen from FIG. 6 that a current density and a luminance in the embodiment is further improved as compared with those in the related art.

An OLED display according to an embodiment will be described below in detail.

FIG. 7 illustrates a circuit configuration of a subpixel.

As shown in FIG. 7, a subpixel may include a switching transistor SWTFT, whose a gate is connected to a scan line (Scan) and one terminal is connected to a data line (Data), and a drive transistor DRTFT, whose a gate is connected to the other terminal of the switching transistor SWTFT and one terminal is connected to a second power supply line VSS. The subpixel may further include a capacitor CST connected between the gate of the drive transistor DRTFT and the second power supply line VSS. The subpixel may further include an organic light emitting diode (OLED) whose an anode electrode is connected to a first power supply line VDD and a cathode electrode is connected to the other terminal of the drive transistor DRTFT.

FIG. 7 shows the n-type switching transistor SWTFT and the n-type drive transistor DRTFT. However, other type transistors may be used.

In the subpixel shown in FIG. 7, a data driver and a scan driver respectively supply a data signal and a scan signal, and then a current applied to the first power supply line VDD flows through the second power supply line VSS. Hence, an image is displayed due to the OLED that emits light.

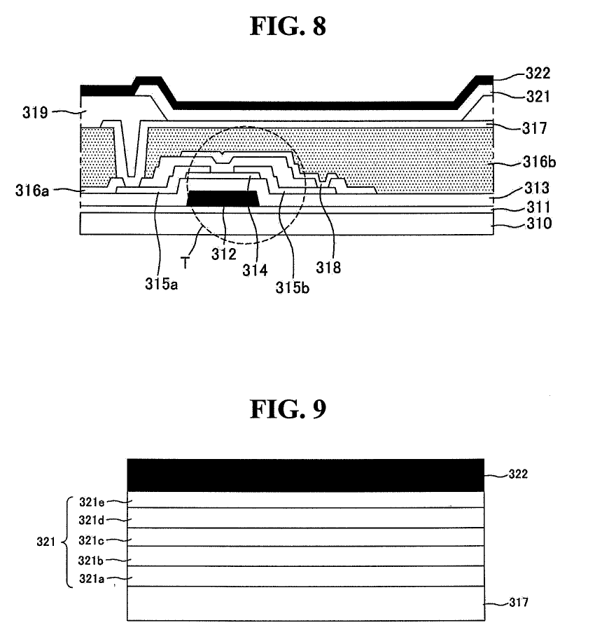

FIG. 8 is a cross-sectional view of the subpixel shown in FIG. 7.

As shown in FIG. 8, the subpixel may include a substrate 310, a transistor T on the substrate 310, a first electrode 317 connected to a source or a drain of the transistor T, an organic light emitting layer 321 on the first electrode 317, and a second electrode 322 on the organic light emitting layer 321. The transistor T may be selectively connected to the first electrode 317 or the second electrode 322 depending on a structure of the subpixel.

A buffer layer 311 may be positioned on the substrate 310. The buffer layer 311 prevents impurities (e.g., alkali ions discharged from the substrate 310) from being introduced during formation of the transistor in a succeeding process. The buffer layer 311 may be formed using silicon oxide (SiO₂), silicon nitride (SiNX), or using other materials.

A gate 312 may be positioned on the buffer layer 311. The gate 312 may be formed of any one selected from the group consisting of molybdenum (Mo), aluminum (Al), chromium (Cr), gold (Au), titanium (Ti), nickel (Ni), neodymium (Nd) and copper (Cu), or a combination thereof. The gate 312 may have a multi-layered structure formed of Mo, Al, Cr, Au, Ti, Ni, Nd, or Cu, or a combination thereof. For example, the gate 312 may have a double-layered structure including Mo/Al—Nd or Mo/Al.

A first insulating layer 313 may be positioned on the gate 312. The first insulating layer 313 may be formed of silicon oxide (SiO_{X}), silicon nitride (SiN_{X}), or a multi-layered structure or a combination thereof, but is not limited thereto.

An active layer 314 may be positioned on the first insulating layer 313. The active layer 314 may be formed of amorphous silicon or crystallized polycrystalline silicon. Although it is not shown, the active layer 314 may include a channel region, a source region, and a drain region. The source region and the drain region may be doped with p-type or n-type impurities. The active layer 314 may include an ohmic contact layer for reducing a contact resistance.

A source 315a and a drain 315b may be positioned on the active layer 314. The source 315a and the drain 315b may have a single-layered structure or a multi-layered structure. When the source 315a and the drain 315b have the single-layered structure, the source 315a and the drain 315b may be formed of Mo, Al, Cr, Au, Ti, Ni, Nd, or Cu, or a combination thereof. When the source 315a and the drain 315b have the multi-layered structure, the source 315a and the drain 315b may have a double-layered structure including Mo/Al—Nd or a triple-layered structure including Mo/Al/Mo or Mo/Al—Nd/Mo.

A second insulating layer 316a may be positioned on the source 315a and the drain 315b. The second insulating layer 316a may be formed of silicon oxide (SiO_{X}), silicon nitride (SiN_{X}), or a multi-layered structure or a combination thereof, but is not limited thereto. The second insulating layer 316a may be a passivation layer.

The transistor T including the gate 312, the source 315a, and the drain 315b may be used as a drive transistor. One of the source 315a and the drain 315b of the drive transistor T may be connected to a shield metal 318 on the second insulating layer 316a. The shield metal 318 may be omitted depending on the structure of the subpixel.

A third insulating layer 316b may be positioned on the second insulating layer 316a to increase a planarization level. The third insulating layer 316b may be formed of an organic material such as polyimide. Other materials may be used for the third insulating layer 316b.

FIG. 8 illustrates a case where the transistor T on the substrate 310 is a bottom gate transistor. However, the transistor T on the substrate 110 may be a top gate transistor.

A first electrode 317 may be positioned on the third insulating layer 316b to be connected to the source 315a or the drain 315b of the transistor T. The first electrode 317 may be formed in each subpixel. The first electrode 317 serving as an anode electrode is formed of IAZTO including Al₂O₃ doped ZnO (AZO) and indium tin oxide (ITO). AZO includes zinc oxide (ZnO) and aluminum oxide (Al₂O₃), and ITO includes indium oxide (In₂O₃) and tin oxide (SnO₂). AZO includes 2% to 7% of Al₂O₃ based on total weight of AZO, and ITO includes 5% to 15% of SnO₂ based on total weight of ITO. When Al₂O₃ content is out of the above range (2% to 7%), a phase of the first electrode 317 may change. Hence, the characteristics of the first electrode 317 are reduced. When SnO₂ content is out of the above range (5% to 15%), a phase of the first electrode 317 may change. Hence, the characteristics of the first electrode 317 are reduced. For example, when AZO includes 5% of Al₂O₃ based on total weight of AZO and ITO includes 10% of SnO₂ based on total weight of ITO, the first electrode 317 has a resistivity of 4.6×10⁻⁴ Ω·cm, a transmittance of 85% at a wavelength of visible light of 550 nm, and a work function of 5.2 eV. On the other hand, when the Al₂O₃ content and the SnO₂ content are out of the above ranges, respectively, the resistivity of the first electrode 317 is greater than 4.6×10⁻⁴ Ω·cm and the transmittance of the first electrode 317 is smaller than 85%.

A bank layer 319 may be positioned on the first electrode 317 to expose a portion of the first electrode 317. The bank layer 319 may be formed of an organic material such as benzocyclobutene (BCB)-based resin, acrylic resin, or polyimide resin. Other materials may be used for the bank layer 319.

The organic light emitting layer 321 may be positioned inside the bank layer 319. For example, the organic light emitting layer 321 may have a structure including a hole injection layer, a hole transport layer, a light emitting layer, an electron transport layer, and an electron injection layer. Other structures may be used.

A second electrode 322 may be positioned on the organic light emitting layer 321. If the first electrode 317 serves as an anode electrode, the second electrode 322 serves as a cathode electrode. The second electrode 322 serving as a cathode electrode may be formed of aluminum (Al), Al alloy, aluminum neodymium (AlNd). Other materials may be used.

FIG. 9 illustrates a structure of an organic light emitting diode including the organic light emitting layer 321. In FIG. 9, the first electrode 317 serves as an anode electrode, and the second electrode 322 serves as a cathode electrode.

As shown in FIG. 9, if an organic light emitting diode is a top emission type OLED, the organic light emitting diode may include the first electrode 317, a hole injection layer 321a, a hole transport layer 321b, a light emitting layer 321c, an electron transport layer 321d, an electron injection layer 321e, and the second electrode 322.

The hole injection layer 321a may function to facilitate the injection of holes. The hole injection layer 321a may be formed of at least one selected from the group consisting of copper phthalocyanine (CuPc), PEDOT(poly(3,4)-ethylenedioxythiophene), polyaniline (PANI) and NPD(N,N-dinaphthyl-N,N′-diphenyl benzidine), but is not limited thereto.

The hole transport layer 321b may function to smoothly transport holes. The hole transport layer 321b may be formed of at least one selected from the group consisting of NPD(N,N-dinaphthyl-N,N′-diphenyl benzidine), TPD(N,N′-bis-(3-methylphenyl)-N,N′-bis-(phenyl)-benzidine, s-TAD and MTDATA(4,4′,4″-Tris(N-3-methylphenyl-N-phenyl-amino)-triphenylamine), but is not limited thereto.

The light emitting layer 321c may be formed of a material capable of producing red, green, blue and white light, for example, a phosphorescence material or a fluorescence material.

In case the light emitting layer 321c produces red light, the light emitting layer 321c includes a host material including carbazole biphenyl (CBP) or N,N-dicarbazolyl-3,5-benzene (mCP). Further, the light emitting layer 321c may be formed of a phosphorescence material including a dopant material including any one selected from the group consisting of PIQIr(acac)(bis(1-phenylisoquinoline)acetylacetonate iridium), PQIr(acac)(bis(1-phenylquinoline)acetylacetonate iridium), PQIr(tris(1-phenylquinoline)iridium) and PtOEP(octaethylporphyrin platinum) or a fluorescence material including PBD:Eu(DBM)3(Phen) or Perylene, but is not limited thereto.

In case the light emitting layer 321c produces green light, the light emitting layer 321c includes a host material including CBP or mCP. Further, the light emitting layer 321c may be formed of a phosphorescence material including a dopant material including Ir(ppy)3(fac tris(2-phenylpyridine)iridium) or a fluorescence material including Alq3(tris(8-hydroxyquinolino)aluminum), but is not limited thereto.

In case the light emitting layer 321c produces blue light, the light emitting layer 321c includes a host material including CBP or mCP. Further, the light emitting layer 321c may be formed of a phosphorescence material including a dopant material including (4,6-F2ppy)2Irpic or a fluorescence material including any one selected from the group consisting of spiro-DPVBi, spiro-6P, distyryl-benzene (DSB), distyryl-arylene (DSA), PFO-based polymer, PPV-based polymer and a combination thereof, but is not limited thereto.

The electron transport layer 321d may function to smoothly transport electrons. The electron transport layer 321d may be formed of at least one selected from the group consisting of Alq3(tris(8-hydroxyquinolino)aluminum, PBD, TAZ, spiro-PBD, BAlq, and SAlq, but is not limited thereto.

The electron injection layer 321e functions to facilitate the injection of electrons. The electron injection layer 321e may be formed of Alq3(tris(8-hydroxyquinolino)aluminum), PBD, TAZ, spiro-PBD, BAlq or SAlq, but is not limited thereto.

At least one of the hole injection layer 321a, the hole transport layer 321b, the electron transport layer 321d, and the electron injection layer 321e may be omitted.

The subpixels having the above-described structure may be formed on the substrate 310 in a matrix format. Because the subpixels on the substrate 310 are weak in moisture or oxygen, the subpixels may be encapsulated using a seal substrate or a protective layer.

The embodiments provide the method of manufacturing the metal oxide electrode capable of replacing the ITO electrode and the OLED display using the same. The embodiments may be applied to a top emission type, a bottom emission type, or a dual emission type OLED display. The embodiments may be applied to an OLED display of a normal structure, in which a cathode electrode is positioned above an anode electrode, and an OLED display of an inverted structure, in which an anode electrode is positioned above a cathode electrode. The metal oxide electrode according to the embodiments may be used for display devices (for example, a liquid crystal display) including a transparent conductive oxide electrode as well as the OLED display.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of manufacturing a metal oxide electrode comprising:
providing a substrate inside a chamber;
providing Al₂O₃ doped ZnO (AZO) including zinc oxide (ZnO) and aluminum oxide (Al₂O₃) inside the chamber;
providing indium tin oxide (ITO) including indium oxide (In₂O₃) and tin oxide (SnO₂) inside the chamber; and
applying a direct current (DC) power to a material including AZO and ITO to form an IAZTO electrode on the substrate.

2. The method of claim 1, wherein AZO includes about 2% to about 7% of Al₂O₃ based on total weight of AZO.

3. The method of claim 1, wherein ITO includes about 5% to about 15% of SnO₂ based on total weight of ITO.

4. The method of claim 1, wherein an internal pressure of the chamber is about 3 mTorr.

5. The method of claim 1, wherein a flow rate of Ar gas injected into the chamber is about 15 sccm.

6. The method of claim 1, wherein distances between the substrate and AZO and ITO are about 100 mm.

7. The method of claim 1, wherein the DC power applied to AZO is about 0 to 100 W.

8. The method of claim 1, wherein the DC power applied to ITO is about 100 W.

9. The method of claim 1, wherein a resistivity of the IAZTO electrode is about 4.6×10⁻⁴ Ω·□, and a transmittance of the IAZTO electrode is about 85% at a wavelength of visible light of 550 nm,

10. The method of claim 1, wherein a work function of the IAZTO electrode is about 5.2 eV.

11. An organic light emitting diode (OLED) display comprising:
a substrate; and
an organic light emitting layer between first and second electrodes that are positioned on the substrate,
wherein the first electrode is formed of IAZTO including Al₂O₃ doped ZnO (AZO) and indium tin oxide (ITO),
wherein AZO includes zinc oxide (ZnO) and aluminum oxide (Al₂O₃), and ITO includes indium oxide (In₂O₃) and tin oxide (SnO₂).

12. The OLED display of claim 11, wherein AZO includes about 2% to about 7% of Al₂O₃ based on total weight of AZO.

13. The OLED display of claim 11, wherein ITO includes about 5% to about 15% of SnO₂ based on total weight of ITO.

14. The OLED display of claim 11, wherein a work function of the first electrode is about 5.2 eV.

15. The OLED display of claim 11, further comprising a transistor on the substrate, the transistor being electrically connected to the first electrode or the second electrode.
